(19) United States
(12) Patent Application Publication
(10) Pub. No.: US 2023/0196236 A1
(43) Pub. Date: Jun. 22, 2023

(54) CITY MANAGEMENT SUPPORT APPARATUS, CITY MANAGEMENT SUPPORT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Masahiro KUWAHARA, Kasukabe-shi (JP); Yukihisa FUJITA, Tokyo-to (JP); Hideo HASEGAWA, Tokyo-to (JP)

(73) Assignee: TOYOTA JIDOSHA KABUSHIKI KAISHA, Toyota-shi (JP)

(21) Appl. No.: 17/971,896

(22) Filed: Oct. 24, 2022

(30) Foreign Application Priority Data
Dec. 20, 2021 (JP) 2021-205844

(51) Int. Cl. G06Q 10/06

(52) U.S. Cl. CPC G06Q 10/06315

(57) ABSTRACT

The city management support apparatus according to the present disclosure is an apparatus that supports management of a city in which a plurality of services sharing a finite resource are simultaneously provided. The city management support apparatus acquires information on a provision status of the resource, and predicts a service achievement level of each of the plurality of services in future by a predetermined time based on the provision status of the resource. Then, the city management support apparatus notifies a user of a high-achievement-level service of a request to refrain from using the high-achievement-level service in exchange for giving an incentive, in response to a decrease in the service achievement level in at least one of the plurality of services due to an abnormality in the provision status of the resource.

### CROSS-REFERENCE TO RELATED APPLICATION

The present application claims priority under 35 U.S.C. §119 to Japanese Patent Application No. 2021-205844, filed Dec. 20, 2021, the contents of which application are incorporated herein by reference in their entirety.

### BACKGROUND

### Field

The present disclosure relates to a city management support apparatus, a city management support method, and a non-transitory computer-readable storage medium storing a city management support program suitable for use in management of a city in which a plurality of services sharing a finite resource are simultaneously provided.

### Background Art

Today, “cities” where services are centrally managed through smart technology are being studied and planned in many locations. The term “city” as used herein means a physical space where people live by being provided with various services, and includes not only a large-scale space such as a so-called smart city but also a medium-scale space such as an underground mall and a small-scale space such as a large-scale building. In such cities, many of the resources provided therein are finite, and in many cases, the finite resources are shared by a plurality of services. In order to maintain the service level in a city as a whole, city management is required in which finite resources can be successfully shared among a plurality of services.

However, it is difficult to say that research has been sufficiently advanced so far on the management of a city where a plurality of services sharing finite resources are simultaneously provided. For example, WO2019/189152 discloses a prior art in which a traffic monitoring apparatus calculates, for each continuous congested route, a priority for taking a measure for eliminating congestion based on at least a vehicle traveling direction in the continuous congested route. However, in the prior art, it is not considered to solve the problem by successful sharing of resources among a plurality of services.

In addition to WO2019/189152, JP2015-187498A, JPH11-353358A, WO2013/084268, JP2016-218912A, and JP2021-033941A can be exemplified as documents indicating the technical level of the technical field related to the present disclosure.

### SUMMARY

The present disclosure has been made in view of the above-described problem, and an object thereof is to provide a technique that contributes to suppressing a decrease in a service level in a city as a whole by causing a plurality of services to successfully share a finite resource.

In order to achieve the above object, the present disclosure provides a city management support apparatus. The city management support apparatus of the present disclosure is an apparatus that supports management of a city in which a plurality of services sharing a finite resource are simultaneously provided. The city management support apparatus according to the present disclosure includes at least one memory storing at least one program and at least one processor executing the at least one program. The at least one program is configured to cause the at least one processor to execute: acquiring information on a provision status of the resource; and predicting a service achievement level of each of the plurality of services in future by a predetermined time based on the provision status of the resource. Furthermore, the at least one program is configured to cause the at least one processor to execute notifying a user of a high-achievement-level service of a request to refrain from using the high-achievement-level service in exchange for giving an incentive in response to a decrease in the service achievement level of at least one of the plurality of services due to an abnormality in the provision status of the resource.

In addition, in order to achieve the above object, the present disclosure provides a city management support method. The city management support method according to the present disclosure is a method for supporting, using a computer, management of a city in which a plurality of services sharing a finite resource are simultaneously provided. The city management support method according to the present disclosure comprises: inputting information on a provision status of the resource into the computer; and predicting, by the computer, a service achievement level of each of the plurality of services in future by a predetermined time based on the provision status of the resource. Further, the city management support method of the present disclosure comprises causing the computer to notify a user of a high-achievement-level service of a request to refrain from using the high-achievement-level service in exchange for giving an incentive in response to a decrease in the service achievement level on at least one of the plurality of services due to an abnormality in the provision status of the resource.

Further, in order to achieve the above object, the present disclosure provides a city management support program. The city management support program according to the present disclosure is a program for supporting, using a computer, management of a city in which a plurality of services sharing a finite resource are simultaneously provided. The city management support program according to the present disclosure is configured to cause a computer to execute: acquiring information on a provision status of the resource; and predicting a service achievement level of each of the plurality of services in future by a predetermined time based on the provision status of the resource. Furthermore, the city management support program according to the present disclosure is configured to cause a computer to execute notifying a user of a high-achievement-level service of a request to refrain from using the high-achievement-level service in exchange for giving an incentive in response to a decrease in the service achievement level on at least one of the plurality of services due to an abnormality in the provision status of the resource. The city management support program according to the present disclosure is stored in a non-transitory computer-readable storage medium.

According to the above-described technique of the present disclosure, a user who has received a notification refrains from using a high-achievement-level service, thereby making it possible to have surplus in the resource. By allocating the surplus of the resource to a service for which a decrease in the service achievement level is predicted, a decrease in the service achievement level of the service can be suppressed. Further, a user who refrains from using the high-achievement-level service receives an incentive, thereby compensating for a disadvantage caused by refraining from using the high-achievement-level service. The above-described technique of the present disclosure provides a place where a resource is shared between different services to achieve successful sharing of the resource, thereby suppressing a decrease in the service level in the city as a whole.

In the above-described technique of the present disclosure, a priority order of provision of the resource between the plurality of services may be calculated based on a service content and the service achievement level of each service, and a request may be notified to a user of a low-priority service among the high-achievement-level services so as to refrain from using the low-priority service in exchange for giving an incentive. This makes it possible to suppress the use of the low-priority service having a low priority among the high-achievement-level service, thereby suppressing a decrease in the service level in the city further as a whole.

In addition, in the above-described technique of the present disclosure, the request may be notified to a user having a reservation to use the high-achievement-level service. By notifying the request to the user who is scheduled to use the high-achievement-level service, it is possible to increase certainty that the use of the high-achievement-level service is suppressed.

In addition, in the above-described technique of the present disclosure, the request may be notified to a user having a prior consent to receive notification of the request. By notifying the request to the user who is scheduled to use the high-achievement-level service, it is possible to increase certainty that the use of the high-achievement-level service is suppressed.

In addition, in the above-described technique of the present disclosure, funds of the incentive may be collected from a provider of a surplus resource utilization service, the surplus resource utilization service being a service using a surplus resource made available by refraining from using the high-achievement-level service. By allowing an object who has received a profit, that is a service provider, to pay compensation, a matching market is formed between a service provider and a service user

Further, in the above-described technique of the present disclosure, the incentive may be digital currency available only in a city. This is convenient for both the administrator and the user, and has the advantage of leading to city activation.

Furthermore, in the above-described technique of the present disclosure, a request may be notified to a provider of the high-achievement-level service to refrain from providing the high-achievement-level service in exchange for giving an incentive. This allows service providers to share the resource with each other.

As described above, the technique of the present disclosure contributes to suppressing a decrease in a service level in a city as a whole by successfully sharing a finite resource among a plurality of services, and is useful in management of a city in which a plurality of services sharing a finite resource are simultaneously provided.

### BRIEF DESCRIPTION OF THE DRAWINGS

FIG. 1 is a diagram showing an overview of a city according to an embodiment of the present disclosure.

FIG. 2 is a block diagram illustrating a configuration of a city management support apparatus according to the embodiment of the present disclosure.

FIG. 3 is a diagram illustrating an operation of the city management support apparatus in a case that the services provided in the city are services sharing a finite number of vehicles.

FIG. 4 is a diagram illustrating an operation of the city management support apparatus in a case that the services provided in the city are services sharing a finite number of vehicles.

FIG. 5 is a diagram illustrating an operation of the city management support apparatus in a case that the services provided in the city are services sharing a finite number of vehicles.

FIG. 6 is a diagram illustrating an operation of the city management support apparatus in a case that the services provided in the city are services sharing a vehicle charger.

FIG. 7 is a diagram illustrating an operation of the city management support apparatus in a case that the services provided in the city are services sharing a vehicle charger.

FIG. 8 is a diagram illustrating an operation of the city management support apparatus in a case that the services provided in the city are services sharing a vehicle charger.

### DETAILED DESCRIPTION

Hereinafter, an embodiment of a city management support apparatus, a city management support method, and a city management support program according to the present disclosure will be described with reference to the drawings. However, in the embodiment described below, when a numerical value such as the number, quantity, amount, or range of each element is mentioned, the present invention is not limited to the mentioned numerical value unless otherwise specified or unless it is clearly specified to the numerical value in principle. In addition, structures and the like described in the following embodiment are not necessarily essential to the present invention except for a case where the structures and the like are clearly specified in particular or a case where the structures and the like are obviously specified in principle.

### 1. City Overview

In the present disclosure, a city refers to a physical space in which people live by receiving the provision of various services. There is no limitation on the size of a city in the present disclosure. A smart city is an example of a large city, an underground mall is an example of a medium-sized city, and a large building is an example of a small city. A virtual space of the Internet that is not a physical space is not included in a city in the present disclosure.

In a city, various services are provided to users. Services are provided using resources of the city. Resources are those used to provide services in a city and include, for example, roads, power supply stations, storage yards, networks, electricity, water, and the like. If the logistics service uses elevators in the building, the elevators are also included in the resources. However, the resources in the present disclosure are finite, and those that are infinite or finite but whose limit is sufficiently high compared to the amount of resources used by the service are not included in the resources in the present disclosure. In a city in the present disclosure, finite resources are shared by a plurality of services.

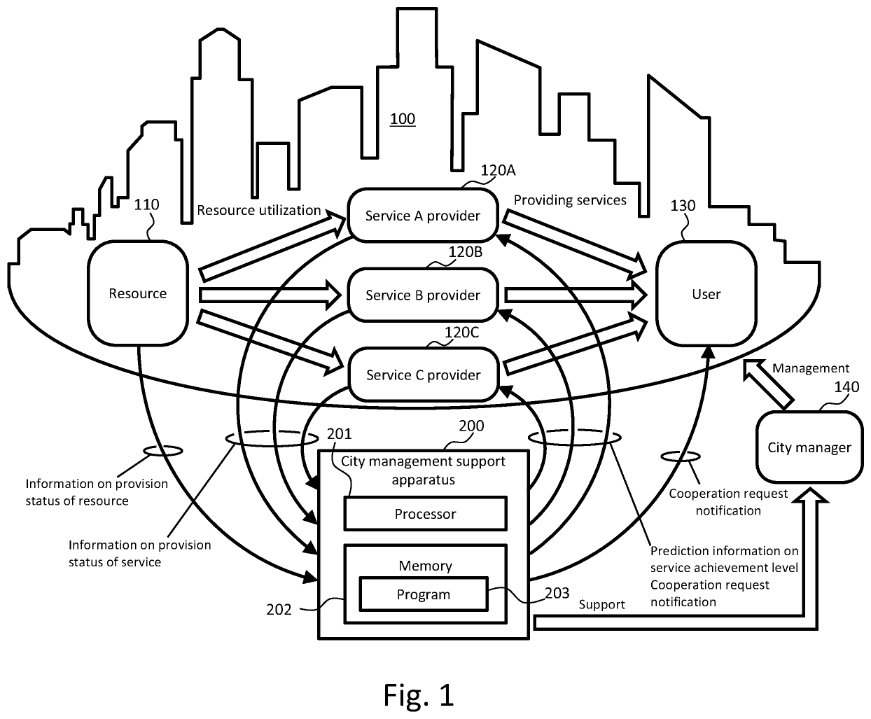

FIG. 1 shows an overview of a city 100 according to an embodiment of the present disclosure. In the city 100 according to the present embodiment, services A, B, and C sharing a finite resource 110 are simultaneously provided to the user 130 from providers 120A, 120B, and 120C of the services A, B, and C. That a plurality of services using the finite resource 110 are simultaneously provided means that one user 130 simultaneously uses the plurality of services, and also means that the plurality of services using the finite resource 110 are not mutually exclusive. That is, any one of the services A, B, and C provided in the city 100 does not exclusively use the resource 110, and any two of the services do not use the resource 110 in an oligopolistic manner.

The provision status of each of the services A, B, and C for the user 130 is affected by the provision status of the resource 110 in the city 100, and in particular, by an abnormality in the provision status. Which service is affected to what degree depends on the content of the abnormality in the provision status of the resource 110. For example, only some services may be affected, or all services may be affected. Depending on the content of the abnormality in the provision status of the resource 110, the service provision method may be changed from the normal provision method to the alternative provision method to suppress the deterioration of the service. However, since the resource 110 is shared, for example, in order to maintain one service, another service may have to be deteriorated. How to suppress the deterioration of the service in the city 100 as a whole when an abnormality occurs in the provision status of the resource 110 is an important issue in management of the city 100.

In the city 100 according to the present embodiment, the provision statuses of the services A, B, and C are collectively managed by the city manager 140 together with the provision status of the resource 110. The city manager 140 monitors the provision status of the resource 110, and has the authority and responsibility to quickly recover if an abnormality occurs in the provision status of the resource 110. However, depending on the type of the resource 110, the city manager 140 may entrust regular maintenance or restoration from an abnormality to another company, or the provision itself of the resource 110 may be performed by another company. The city manager 140 is basically a business operator different from the service providers 120A, 120B, and 120C. Except for the case where the city manager 140 provides the service by itself, the city manager 140 basically cannot change the method of providing the service.

In the city 100 according to the present embodiment, the city manager 140 is required to efficiently and appropriately manage both the resource 110 and the services A, B, and C due to the continuous development of the city 100. A city management support apparatus 200 according to the embodiment of the present disclosure is an apparatus for supporting efficient and appropriate management of the city 100 by the city manager 140. The city management support apparatus 200 is a computer comprising at least one memory 202 storing at least one program 203 and at least one processor 201 executing the at least one program 203. When the at least one program 203 stored in the at least one memory 202 is executed by the at least one processor 201, various functions for supporting the city manager 140 are realized. However, the city management support apparatus 200 may be constituted by a single computer or may be constituted by a plurality of computers connected via a network.

The city management support apparatus 200 does not manage the city 100 by itself, but supports management of the city 100 by the city manager 140. In order to support the management of the city 100, the city management support apparatus 200 acquires information on the provision status of the resource 110 and information on the provision status of each of the services A, B, and C. The city management support apparatus 200 predicts the achievement level of each of the services A, B, and C based on the acquired information, and provides prediction information of the achievement level of each of the services A, B, and C to be provided to each of the service providers 120A, 120B, and 120C. Details of the service achievement level will be described later. In addition, the city management support apparatus 200 notifies the user 130 and the service providers 120A, 120B, and 120C of a cooperation request for maintaining the service level in the city 100 as a whole as necessary. In this way, the city management support apparatus 200 supports the management of the city 100 by the city manager 140 through an approach for maintaining the city service by providing notifications and information to the user 130 and the service providers 120A, 120B, and 120C. The next section describes the city management support apparatus 200 in more detail.

### 2. Configuration of City Management Support Apparatus

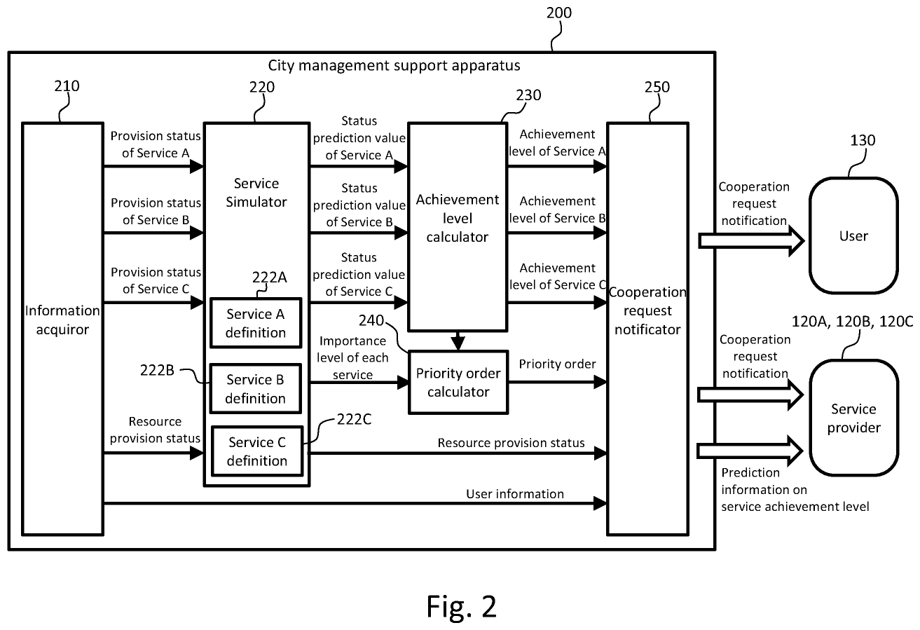

FIG. 2 is a block diagram showing the configuration of the city management support apparatus 200. The city management support apparatus 200 includes an information acquiror 210, a service simulator 220, an achievement level calculator 230, a priority order calculator 240, and a cooperation request notificator (notification unit) 250. These elements constituting the city management support apparatus 200 are functions of the city management support apparatus 200 implemented when the at least one program 203 stored in the at least one memory 202, specifically, the city management support program is executed by the at least one processor 201.

The information acquiror 210 acquires information necessary for management of the city 100 from the city 100. The information acquired by the information acquiror 210 includes information about the provision status of the resource 110 in the city 100. The information on the provision status of the resource 110 is acquired from, for example, information detected by various sensors installed in the city 100, information provided from the service providers 120A, 120B, and 120C, or information provided from the user 130 including information on the SNS. The information on the provision status of the resource 110 acquired by the information acquiror 210 is input to the service simulator 220.

The information acquired by the information acquiror 210 includes information on the provision status of each of the services A, B, and C. The information on the provision status of the service A is acquired from the service provider 120A. The information on the provision status of the service B is acquired from the service provider 120B. The information on the provision status of the service C is acquired from the service provider 120C. However, for example, in a case where two services are provided by the same provider, information on the provision status of the two services is acquired from that provider. It is also possible to acquire the information on the provision status of the service from information provided from the user 130 including information on the SNS. The information on the provision status of each of the services A, B, and C acquired by the information acquiror 210 is input to the service simulator 220.

In addition, the information acquired by the information acquiror 210 includes user information on the user 130 who enjoys at least one of the services A, B, and C in the city 100. The user information includes reservation information of the services A, B, and C for each user 130. In addition, the user information may include information whether or not each user 130 accepts reception of the cooperation request notification. The information acquiror 210 acquires reservation information included in the user information from each of the service providers 120A, 120B and 120C. The information acquiror 210 acquires information directly from the user 130 regarding whether or not to accept the cooperation request notification, and registers the information in the database. The user information acquired by the information acquiror 210 is input to the cooperation request notificator 250.

The service simulator 220 is a simulator that predicts the state of a service in the future by a predetermined time using a prediction model. Inputs to the service simulator 220 are information on the current provision status of each of the services A, B, and C and information on the current provision status of the resource 110. The service simulator 220 predicts, using the prediction model, the status of each of the services A, B, and C in the future by a predetermined time based on the input information. The prediction time is, for example, 10 minutes, 1 hour, 2 hours, or the like, and is determined according to the content of the service.

In the prediction model used by the service simulator 220, parameters relating to the relationship between the resource 110 and the service are created in advance in accordance with the specifications of the city 100. For example, in a case where the service provided in the city 100 is a traffic service or a logistics service, parameters such as the states of buildings or roads, the locations and conditions of moving bodies, a resident model, and a usage method of the moving bodies by the service are created in advance. The resident model is a model of residents in the city 100. Residents affect the relationship between resource 110 and services, such as sometimes becoming an obstacle to moving bodies and sometimes using roads. In the resident model, according to the content of the service, the movement of each resident may be simulated or the movement as a group may be simulated.

In the prediction model used by the service simulator 220, a service definition is set for each service. For example, in a case where the service provided in the city 100 is a traffic service, a route, a timetable, a predicted number of people getting on and off, an alternative method of a service provision method when an abnormality occurs in the provision status of the resource 110, and the like are set as the service definition. In a case where the service provided in the city 100 is a logistics service, the predicted number of receipts, the predicted destination, an alternative method of a service provision method when an abnormality occurs in the provision status of the resource 110, and the like are set as the service definition. In addition, an importance level determined from the content of the service is set for each service as one of service definitions. In the service simulators 220, the definition of the service A is set in the definition setting section 222A, the definition of the service B is set in the definition setting section 222B, and the definition of the service C is set in the definition setting section 222C. The service definitions set in the definition setting sections 222A, 222B, and 222C can be updated.

The prediction of the state of the service in the future by the predetermined time by the service simulator 220 may be continuously executed, or may be executed on condition that an abnormality occurs in the provision status of the resource 110. The abnormality in the provision status of the resource 110 is an abnormality that affects a service achievement level to be described later, and is defined in advance for each resource and each service. By setting the abnormality in the provision status of the resource 110 as the execution condition of the prediction, it is possible to reduce the load on the processor 201 and to suppress the use of power associated with the calculation.

The status prediction values of the services A, B, and C are output from the service simulator 220. That is, each of the prediction results of the states of the services A, B, and C in the future by the predetermined time is represented by one numerical value. The status prediction values of the services A, B, and C are input to the achievement level calculator 230.

The achievement level calculator 230 calculates a service achievement level of each of the services A, B, and C based on the status prediction values of the services A, B, and C input from the service simulator 220. The service achievement level is a numerical value indicating an impact of service deterioration on the user 130, and is defined as a numerical value indicating a degree of deviation from a predefined level, such as a service level agreement (SLA). The achievement levels of the services A, B, and C calculated by the achievement calculator 230 are input to the priority calculator 240 and the cooperation request notificator 250.

The priority order calculator 240 receives the achievement levels of the services A, B, and C input from the achievement level calculator 230 and the importance levels of the services A, B, and C input from the service simulator 220. The priority order calculator 240 calculates the priority order of the provision of the resource 110 between the services A, B, and C based on the importance level and the service achievement level of each service. The priority order of the provision of the resource 110 between the services A, B, and C calculated by the priority order calculator 240 is input to the cooperation request notificator 250.

The cooperation request notificator 250 receives the achievement levels of the services A, B, and C input from the achievement level calculator 230 and the priority order of the provision of the resource 110 between the services A, B, and C input from the priority order calculator 240. In addition, the cooperation request notificator 250 receives information on the provision status of the resource 110 input from the service simulator 220 and user information input from the information acquiror 210.

The cooperation request notificator 250 provides the service providers 120A, 120B, and 120C with the prediction information of the service achievement levels received from the achievements level calculator 230. The prediction information of the service achievement level can be used as reference information for the service providers 120A, 120B, and 120C to operate the service. In addition, the prediction information of the service achievement level of each of the services A, B, and C is also provided to the city manager 140 together with the information on the provision status of the resource 110.

The cooperation request notificator 250 determines the necessity of the cooperation request notification based on the information on the provision status of the resource 110 and the prediction information of the service achievement level. Specifically, when an abnormality occurs in the provision status of the resource 110 and the service achievement level of at least one of the services A, B, and C decreases, the cooperation request notificator 250 determines that the cooperation request notification is necessary.

Whom the cooperation request notificator 250 notifies the cooperation request includes a user of a high-achievement-level service having a high service achievement level among the users 130. The user of the high-achievement-level service is notified of a request to refrain from using the high-achievement-level service in exchange for giving an incentive. The user of the high-achievement-level service is a user who is scheduled to use the high-achievement-level service within a predetermined time. However, the cooperation request notification is not given to a user who refuses to receive the cooperation request notification. A user whose acceptance or rejection of the reception of the cooperation request notification is not registered in the database is determined as being rejecting the reception of the cooperation request notification. Examples of incentives given to users include points exchangeable for goods or services, and digital currency available only in the city 100.

Whom the cooperation request notificator 250 notifies the cooperation request includes a provider of the high-achievement-level service among the service providers 120A, 120B, and 120C. The provider of the high-achievement-level service is notified of a request to refrain from providing the high-achievement-level service in exchange for giving an incentive. However, there may be no exchange for giving an incentive. That is, based on the principle of mutual assistance among the service providers 120A, 120B, and 120C, the provider of the high-achievement-level service may be requested to refrain from providing the high-achievement-level service without an incentive.

### 3. Specific Example of City Management Support Method by City Management Support Apparatus

### 3-1. First Specific Example

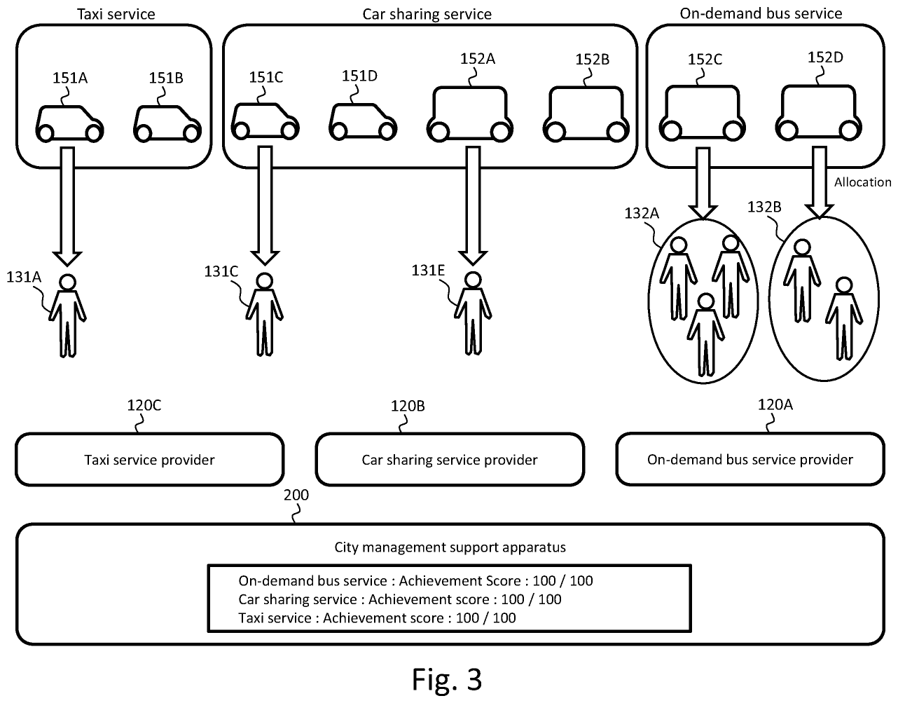

As the first specific example, an example in which a service provided in the city 100 is a service of sharing vehicles will be described. FIGS. 3 to 5 are diagrams for explaining the first specific example.

In the first specific example, the resource 110 shared between services is vehicles. Three services, an on-demand bus service, a car sharing service, and a taxi service, share vehicles. In the example shown in FIGS. 1 and 2, the on-demand bus service is the service A, and the on-demand bus service provider is the service provider 120A. The car sharing service is the service B, and the car sharing service provider is the service provider 120B. The taxi service is the service C, and the taxi service provider is the service provider 120C.

In the first specific example, vehicles shared among services are passenger car type vehicles 151A to 151D in which one person or a small number of persons can ride, and minibus type (or minivan type) vehicles 152A to 152D in which a large number of persons can ride. These vehicles 151A to 151D and 152A to 152D are owned by the city 100. Which vehicle is assigned to which service is determined on the previous day based on statistical data on demand of each service, weather forecast of the next day, event information of the next day, and the like. The vehicles may be self-driving cars or driver cars. A driver car is assigned to a service as a set with a driver. Assignment of the vehicles 151A to 151D and 152A to 152D to each service, that is, assignment of the resource 110 to each service is also one function of the service simulator 220 of the city management support apparatus 200.

FIG. 3 shows an example of the assignment of the vehicles 151A to 151D and 152A to 152D to each service. The taxi service is assigned two passenger car type vehicles 151A and 151B. The car sharing service is assigned two passenger car type vehicles 151C and 151D and two minibus type vehicles 152A and 152B. The on-demand bus service is assigned two minibus type vehicles 152C and 152D.

FIG. 3 shows a use state of each service at a certain time. In the taxi service, only the vehicle 151A is used by the user 131A. In the car sharing service, the vehicle 151C is used by the user 131C, and the vehicle 152A is used by the user 131E. Although the vehicle 152A is a minibus type vehicle, it can be used by one person as long as it is vacant. In the on-demand bus service, the vehicle 152C is used by a user group 132A of three users, and the vehicle 152D is used by a user group 132B of two users.

While the on-demand bus service, the car sharing service, and the taxi service are provided in the city 100, the city management support apparatus 200 calculates the achievement level of each service. The service achievement level is represented by a score (achievement level score). A state of proceeding as planned satisfying the SLA is the highest state as the service achievement level, and the achievement level score in this state is set to 100 points which is the highest point. The achievement level score is calculated in a point deduction scoring manner.

For example, in the car sharing service and the taxi service, the service simulator 220 predicts the shortage number of vehicles in the future by a predetermined time. Then, the achievement level score in a state in which the reserved vehicles are reliably prepared and the service is provided without delay is set to 100 points, and the achievement level score is reduced in accordance with the ratio of the shortage number of vehicles to the planned number of vehicles. In the example shown in FIG. 3, since vehicles are allocated to users without delay in both the car sharing service and the taxi service, the achievement level score is 100 points in both the services.

In the on-demand bus service, a congestion level of each vehicle in the future by a predetermined time is predicted by the service simulator 220. The congestion level may be calculated as, for example, a ratio of the number of passengers to the capacity. The congestion level of the on-demand bus service as a whole is calculated by summing or averaging the congestion level of all vehicles. The achievement level score in a state in which the congestion level is equal to or less than a reference value is set to 100 points, and the achievement level score is reduced as the congestion level becomes larger than the reference value. In the example shown in FIG. 3, since all the vehicles 152C and 152D are operated without congestion, the achievement level score of the on-demand bus service is 100 points.

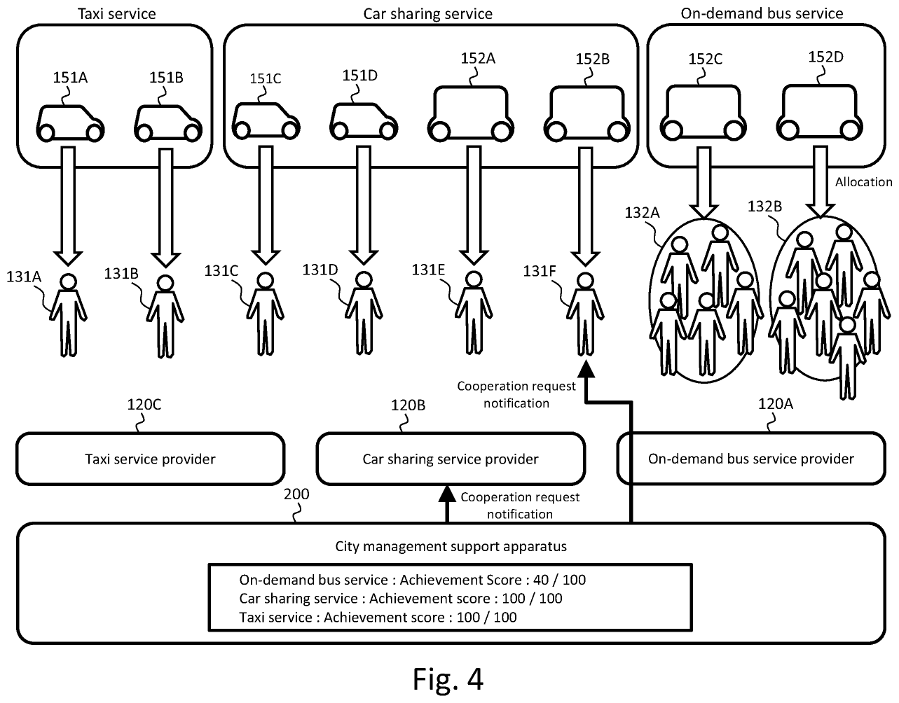

FIG. 4 shows a use state of each service when time has elapsed from the time of the state shown in FIG. 3. Here, it is assumed that a reservation system for the on-demand bus service detects that the demand for reservation of the on-demand bus service is higher than expected. Alternatively, it is assumed that a people-flow detection system using city sensors (for example, camera sensors) installed in the city 100 detects that more people than expected are present in the city. The city management support apparatus 200 simulates whether or not the on-demand bus service, the car sharing service, and the taxi service can be provided in compliance with the SLA by the service simulator 220 in response to the fact that a people-flow detected by the city sensors exceeds a threshold.

As a result of the simulation, it is found that by sharing the demand among the services, it is possible to cope with an increase in the demand. However, it is found that in the on-demand bus service, the service achievement level decreases due to an increase in the congestion levels of the vehicles 152C and 152D, and the achievement level score becomes lower than the threshold. While the capacity of each of the vehicles 152C and 152D is four, the number of the user group 132A of users who simultaneously use the vehicles 152C is five, and the number of the user group 132B of users who simultaneously use the vehicles 152D is six.

In this case, the cooperation request notificator 250 considers the use state of each of the car sharing service and the taxi service in which the high service achievement level is maintained and determines the necessity of the cooperation request notification. In the example shown in FIG. 4, minibus type vehicles 152A and 152B used in the car sharing service are reserved by one user 131E and one user 131F, respectively. As a result of the simulation, it is found that if one of the vehicles 152A and 152B can be assigned to the on-demand bus service, it is possible to suppress a decrease in the service achievement level of the on-demand bus service.

In order to additionally assign a vehicle to the on-demand bus service, it is necessary to cause one of the users 131E and 131F to give up the use of the car sharing service. The cooperation request notificator 250 selects one of the users 131E and 131F based on the user information, and notifies the cooperation request to give up the use of the car sharing service by the vehicle 152A or 152B. The cooperation request notification presents an incentive to be granted for accepting the cooperation request. When the user 131E refuses to receive the cooperation request notification and the user 131F accepts to receive the cooperation request notification, the cooperation request notificator 250 notifies the user 131F of the cooperation request. When both the users 131E and 131F agree to receive the cooperation request notification, the notification destination of the cooperation request may be randomly selected.

In addition, in parallel with notifying the user 131F of the cooperation request, the cooperation request notificator 250 also notifies the car sharing service provider 120B of the cooperation request. The user 131F who is notified of the cooperation request may or may not accept the cooperation request. On the other hand, the car sharing service provider 120B is notified that the assignment of the vehicle 152B is to be changed from the on-demand bus service to the car sharing service as a decision under the condition that the user 131F agrees with the cooperation request.

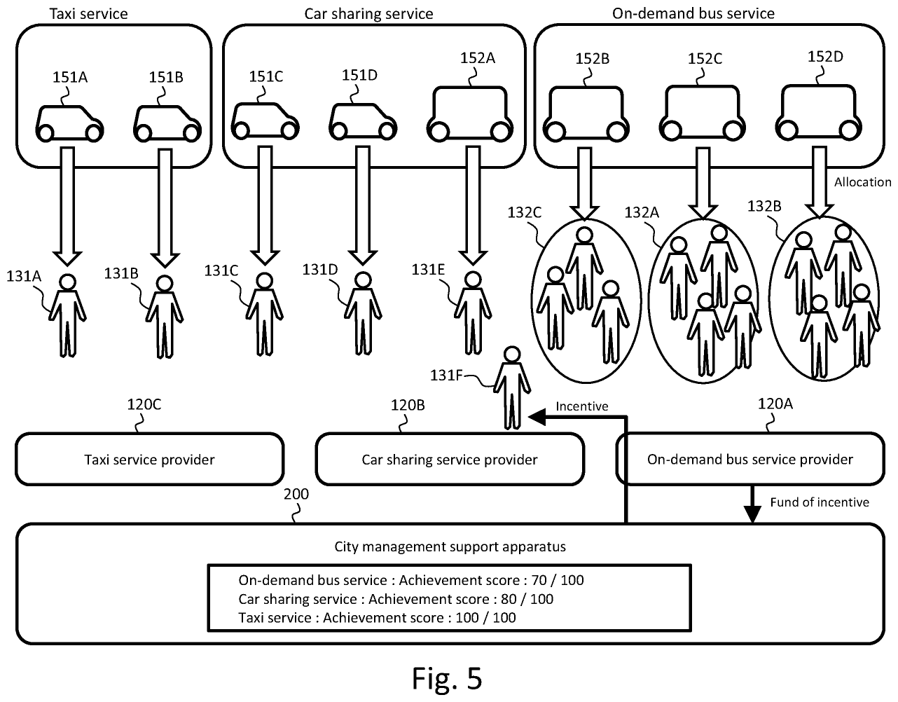

FIG. 5 shows a use state of each service realized when the user 131F accepts the cooperation request. When the user 131F accepts the cooperation request, the vehicle 152B is assigned to the on-demand bus service. When the vehicle 152B is used by a user group 132C of users, the number of users in the user group132A using the vehicle 152C decreases, and the number of users in the user group 132B using the vehicle 152D also decreases. As a result, the congestion levels of the vehicles 152B, 152C, and 152D in the on-demand bus service as a whole decrease, and the achievement level score of the service achievement level increases. On the other hand, the inability to provide a vehicle for the user 131F decreases the achievement level score of the service achievement level of the car sharing service. However, since the achievement level score is maintained to be equal to or greater than the threshold (for example, 50 points) in all services, the service level in the city 100 as a whole is improved overall.

When the user 131F accepts the cooperation request, an incentive is given to the user 131F in exchange for giving up the use of the vehicle 152B. The incentive may be directly given from the city management support apparatus 200 to the user 131F, or may be given via the on-demand bus service provider 120A to which the vehicle 152B is given. The fund of the incentive is collected from the service provide 120A of the on-demand bus service who can suppress a decrease in the service level by being given the vehicle 152B.

As described above, in the first specific example, the user 131F who receives the cooperation request notification refrains from using the car sharing service, so that a surplus is generated in the number of vehicles which is the resource 110. Since the vehicle 152B as the surplus of the resource 110 is assigned to the on-demand bus service, the decrease in the service achievement level of the on-demand bus service is suppressed. In addition, the user 131F who refrains from using the car sharing service receives the incentive, and the disadvantage of the user 131F caused by refraining from using the car sharing service is compensated.

The city management support apparatus 200 provides a place where the resource 110 is shared between different services, that is, a matching market. In the first specific example, a decrease in the service level in the city 100 as a whole is suppressed by successfully sharing the vehicles owned by the city 100 between the on-demand bus service, the car sharing service, and the taxi service in the matching market.

### 3-2. Second Specific Example

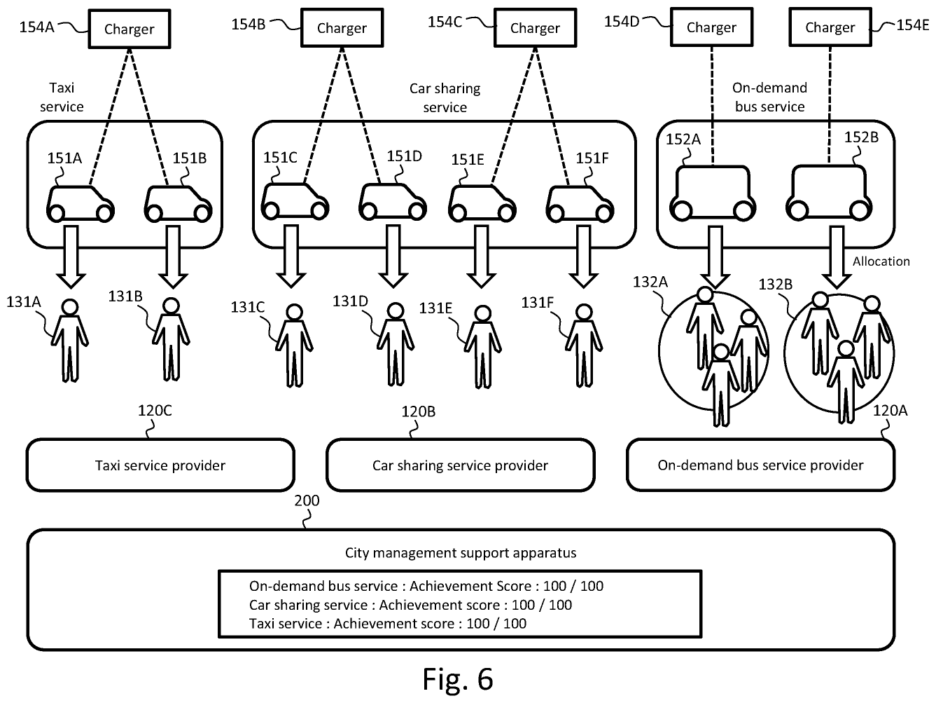

As the first second example, an example in which a service provided in the city 100 is a service of sharing chargers for charging an electric vehicle will be described. FIGS. 6 to 8 are diagrams for explaining the second specific example.

In the first embodiment, the resource 110 shared between services is chargers for charging an electric vehicle. Three services, an on-demand bus service, a car sharing service, and a taxi service, share chargers. In the example shown in FIGS. 1 and 2, the on-demand bus service is the service A, and the on-demand bus service provider is the service provider 120A. The car sharing service is the service B, and the car sharing service provider is the service provider 120B. The taxi service is the service C, and the taxi service provider is the service provider 120C.

In the second concrete example, the city 100 has passenger car type vehicles 151A to 151F in which one person or a small number of persons can ride and minibus type (or minivan type) vehicles 152A to 152B in which a large number of persons can ride. The taxi service uses two passenger car type vehicles 151A and 151B. The car sharing service uses four passenger car type vehicles 151C to 151F. The on-demand bus service uses two minibus type vehicles 152A and 152B.

All vehicles 151A to 151F and 152A to 152B possessed by the city 100 are chargeable electric vehicles, more specifically, battery electric vehicles (BEVs) traveling with a motor using electric power supplied from a chargeable in-vehicle battery. In order to charge vehicles 151A to 151F and 152A to 152B, a plurality of chargers 154A to 154E capable of quick charging are arranged in the city 100. Each of the chargers 154A to 154E is assigned to vehicles for each service in advance. Which vehicle is assigned to which service is determined on the previous day based on statistical data on demand of each service, weather forecast of the next day, event information of the next day, and the like. Assignment of the chargers 154A to 154E to each service is one function of the service simulator 220 of the city management support apparatus 200.

FIG. 6 shows an example of the assignment of the chargers 154A to 154E to each service. The charger 154A is assigned to two vehicles 151A and 151B for the taxi service. The charger 154B is assigned to the two vehicles 151C and 151D for the car sharing service, and the charger 154C is assigned to the two vehicles 151E and 151F for the car sharing service. The charger 154D is assigned only to the vehicle 152A for the on-demand bus service, and the charger 154E is assigned only to the vehicle 152B for the on-demand bus service.

FIG. 6 shows a use state of each service at a certain time. In the taxi service, the vehicles 151A and 151B are used by the users 131A and 131B respectively. In the car sharing service, the vehicles 151C to 151F are used by the users 131C to 131F respectively. In the on-demand bus service, the vehicles 152A and 152B are used by the user groups 132A and 132B respectively. At this time, all the chargers 154A to 154E are functioning normally.

While the on-demand bus service, the car sharing service, and the taxi service are provided in the city 100, the city management support apparatus 200 calculates the achievement level of each service. In the example shown in FIG. 6, since vehicles are allocated to users without delay in both the car sharing service and the taxi service, the achievement level score is 100 points in both the services. Further, in the example shown in FIG. 6, since all vehicles 152A and 152B are operated without congestion, the achievement level score of the on-demand bus service is also 100 points.

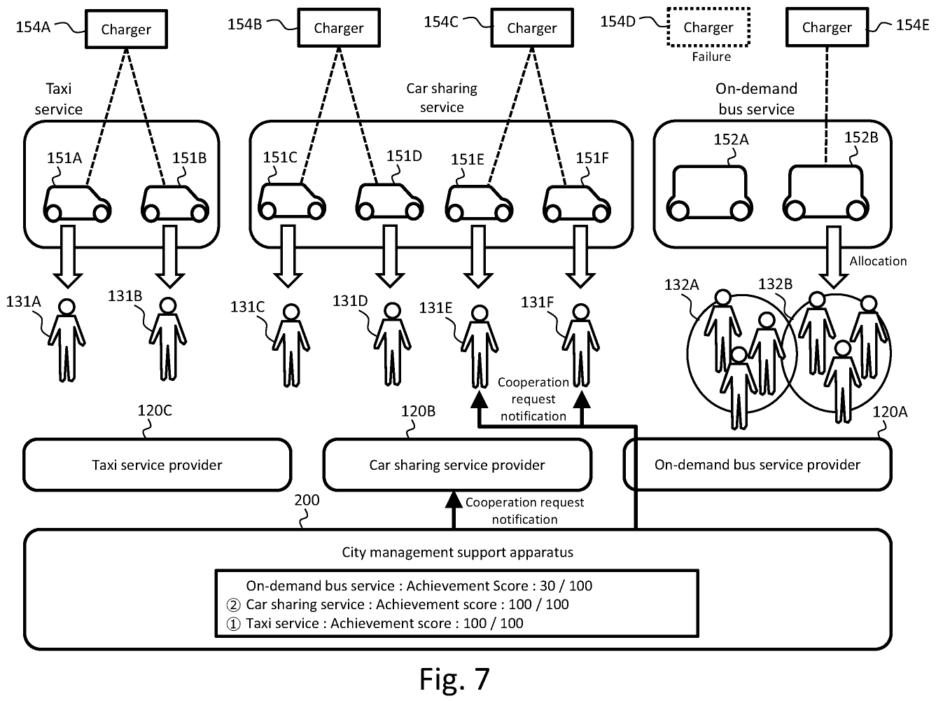

FIG. 7 shows a use state of each service when time has elapsed from the time of the state shown in FIG. 6. Here, it is assumed that a failure in the charger 154D used in the on-demand bus service is detected by city sensors (for example, ammeters or voltmeters mounted on electric vehicles). The city management support apparatus 200 simulates whether or not the on-demand bus service, the car sharing service, and the taxi service can be provided in compliance with the SLA by the service simulator 220 in response to the failure in the charger 154D being detected by the city sensors. In the simulation, for example, information on a current service state for each service and charging reservation information are used as input information. The information on the state of the vehicle includes, for example, a vehicle position, the number of passengers, the number of reservations, and the like.

When the vehicle 152A for the on-demand service cannot be operated due to the failure in the charger 154D, the user group 132A, which have reserved the vehicle 152A, has to be transported together with the user group 132B by one vehicle 152B. However, as a result of the simulation, it is found that when such an operation is performed, the service achievement level of the on-demand service significantly decreases due to an increase in the congestion level in the vehicle 152B. In the example shown in FIG. 7, the achievement level scores of the car sharing service and the taxi service that are not affected by the failure in the charger 154D are maintained at high values, whereas only the achievement level score of the on-demand service is lower than the threshold (for example, 50 points).

In this case, the cooperation request notificator 250 considers the use state of each of the car sharing service and the taxi service in which the high service achievement level is maintained and determines the necessity of the cooperation request notification. As a result of the simulation, it is found that if any one of the chargers 154A, 154B, and 154C used in the taxi service or the car sharing service can be assigned to the on-demand bus service, it is possible to suppress a decrease in the service achievement level of the on-demand bus service.

The charger to be assigned to the on-demand bus service among the charger 154A used in the taxi service and the chargers 154B and 154C used in the car sharing service is determined by the priority order of the provision of the resource 110 between the services. The priority order is calculated based on the service content and the service achievement level of each service. For example, the priority is calculated to be higher as the current service achievement level is higher, the priority is calculated to be higher as the influence (importance) of the service on the operation of the city 100 is larger, and the priority is calculated to be higher as the number of people who use the service predicted within a predetermined time in the future is larger.

In the example shown in FIG. 7, the car sharing service has a lower priority than the taxi service. Therefore, one of the chargers 154B and 154C used in the car sharing service, which is a low-priority service, is assigned to the on-demand bus service. When the charger 154B is assigned to the on-demand bus service, the vehicles 151C and 151D cannot be operated. In this case, it is necessary to have the users 131C and 131D, who reserve these vehicles, to give up the use of the car sharing service. On the other hand, when the charger 154C is assigned to the on-demand bus service, the vehicles 151E and 151F cannot be operated. In this case, it is necessary to have the users 131E and 131F, who reserve these vehicles, to give up the use of the car sharing service.

The cooperation request notificator 250 selects one of a group of the users 131C and 131D and a group of the users 131E and 131F based on the user information. When the user 131C or 131D refuses to receive the cooperation request notification and the users 131E and 131F accept to receive the cooperation request notification, the cooperation request notificator 250 notifies the users 131E and 131F of the cooperation request. The cooperation request notification includes a request to give up the use of the car sharing service by the vehicle 151E or 151F, and also presents an incentive given by accepting the cooperation request. Furthermore, when the current location and the destination of the user 131F are close to the route of the vehicle 152A as the on-demand bus, a proposal is made to the user 131F to transfer to the vehicle 152A.

In addition, in parallel with notifying the users 131E and 131F of the cooperation request, the cooperation request notificator 250 also notifies the car sharing service provider 120B of the cooperation request. The users 131E and 131F who are notified of the cooperation request may or may not accept the cooperation request. On the other hand, the car sharing service provider 120B is notified that the assignment of the charger 154C is to be changed from the on-demand bus service to the car sharing service as a decision under the condition that the users 131E and 131F agree with the cooperation request.

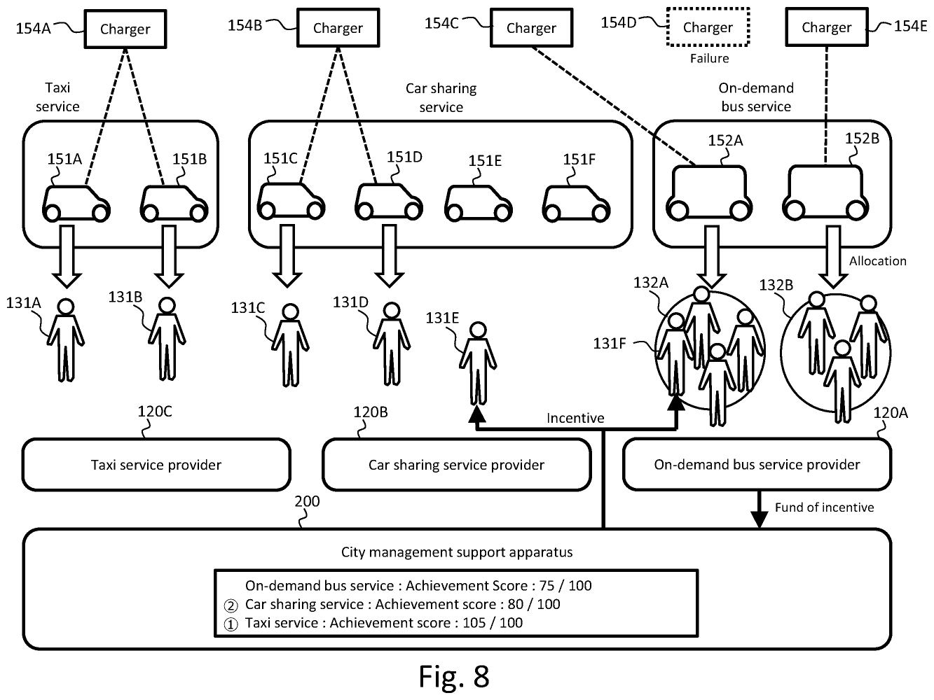

FIG. 8 shows a use state of each service realized when the users 131E and 131F accept the cooperation request. When the users 131E and 131F accept the cooperation request, the charger 154C is assigned to the on-demand bus service. By assigning the charger 154C to the on-demand bus service, charging the vehicle 152A becomes possible using the charger 154C instead of the failed charger 152D.

By making the vehicle 152A available for on-demand bus service, it is possible to carry the user groups 132A and 132B separately into two vehicles 152A and 152B, and thereby the congestion level of the vehicle 152B decreases. As a result, the achievement level score of the service achievement level of the on-demand bus service as a whole increases totally. On the other hand, the inability to provide vehicles for the users 131E and 131F decreases the achievement level score of the service achievement level of the car sharing service. However, since the achievement level score is maintained to be equal to or greater than the threshold (for example, 50 points) in all services, the service level in the city 100 as a whole is improved.

When the users 131E and 131F accept the cooperation request, an incentive is given to the users 131E and 131F in exchange for giving up the use of the vehicle 152E or 152F. Further, the user 131F can transfer to the vehicle 152A for the on-demand bus by following the proposal presented in the cooperation request notification. The incentive may be directly given from the city management support apparatus 200 to the users 131E and 131F, or may be given via the on-demand bus service provider 120A to which the charger 154C is given. The fund of the incentive is collected from the service provide 120A of the on-demand bus service who can suppress a decrease in the service level by being given the charger 154C.

As described above, in the second specific example, the users 131E and 131F who receive the cooperation request notification refrain from using the car-sharing service, so that a surplus is generated in the number of chargers which is the resource 110. Since the charger 154C as the surplus of the resource 110 is assigned to the on-demand bus service, the decrease in the service achievement level of the on-demand bus service is suppressed. In addition, since the users 131E and 131F who refrain from using the car sharing service receive the incentive, the disadvantage of the users 131E and 131F caused by refraining from using the car sharing service is compensated.

The city management support apparatus 200 provides a place where the resource 110 is shared between different services, that is, a matching market. In the second specific example, a decrease in the service level in the city 100 as a whole is suppressed by successfully sharing the chargers owned by the city 100 between the on-demand bus service, the car sharing service, and the taxi service in the matching market.

### 4. Others

Roads may also be a finite resource 110 of the city 100. The services shearing roads include a logistics service in addition to the traffic service such as the on-demand bus service, the car sharing service, and the taxi service. The abnormality in the road as the resource 110 is, for example, occurrence of a traffic jam. When a traffic jam occurs, a delay occurs in both the traffic service and the logistics service, and the service achievement level decreases. For example, in a case where the service achievement level of the logistics service decreases in a situation where the service achievement level of the traffic service is maintained, a request to refrain from using the traffic service may be notified to the user of the traffic service in exchange for giving an incentive.

The network may also be referred to as a finite resource 110 of the city 100. Examples of the services sharing a network include a remote driving service for a remote driving vehicle and a moving image distribution service. The abnormality in the provision state of the network as the resource 110 is, for example, that the bandwidth becomes tight due to congestion of the network. When the bandwidth of the network becomes tight, remote driving using mobile communication cannot be continued, and switching from remote driving to automatic driving tends to occur. Therefore, a remote driving rate can be used as the service achievement level of the remote driving service. For example, when the remote driving rate decreases due to tight bandwidth, a request to refrain from using the moving image distribution service may be notified to the user of the moving image distribution service in exchange for giving an incentive.

Electric power may also be a finite resource 110 of the city 100. Services sharing electric power include a hospital cooling and heating management service and an personal cooling and heating management service. For example, when the electricity supply becomes tight, a request to refrain from using the personal cooling and heating management service may be notified to the user of the personal cooling and heating management service in exchange for giving an incentive.

What is claimed is:

1. A city management support apparatus that supports management of a city in which a plurality of services sharing a finite resource are simultaneously provided, the city management support apparatus comprising:
at least one memory storing at least one program; and
at least one processor configured to execute the at least one program,
wherein the at least one program is configured to cause the at least one processor to execute:
acquiring information relating to a provision status of the resource;
predicting a service achievement level of each of the plurality of services in future by a predetermined time based on the provision status of the resource; and
notifying a user of a high-achievement-level service of a request to refrain from using the high-achievement-level service in exchange for giving an incentive, in response to a decrease in the service achievement level in at least one of the plurality of services due to an abnormality in the provision status of the resource.

2. The city management support apparatus according to claim 1,
wherein the at least one program is configured to cause the at least one processor to execute:
calculating a priority order of provision of the resource between the plurality of services based on a service content and the service achievement level of each service; and
notifying a user of a low-priority service among the high-achievement-level services of a request to refrain from using the low-priority service in exchange for giving an incentive.

3. The city management support apparatus according to claim 1,
wherein the at least one program is configured to causes the at least one processor to execute notifying the request to a user having a reservation to use the high-achievement-level service.

4. The city management support apparatus according to claim 1,
wherein the at least one program is configured to cause the at least one processor to execute notifying the request to a user having a prior consent to receive notification of the request.

5. The city management support apparatus according to claim 1,
wherein the at least one program is configured to cause the at least one processor to further execute collecting funds of the incentive from a provider of a surplus resource utilization service, the surplus resource utilization service being a service using a surplus resource made available by refraining from using the high-achievement-level service.

6. The city management support apparatus according to claim 1,
wherein the incentive is digital currency available only in the city.

7. The city management support apparatus according to claim 1,
wherein the at least one program is configured to cause the at least one processor to further execute notifying a provider of the high-achievement-level service of a request to refrain from providing the high-achievement-level service in exchange for giving an incentive.

8. A city management support method for supporting, using a computer, management of a city in which a plurality of services sharing a finite resource are simultaneously provided, the city management support method comprising:
inputting information related to a provision status of the resource to the computer;
predicting, by the computer, a service achievement level of each of the plurality of services in future by a predetermined time based on the provision status of the resource; and
causing the computer to notify a user of a high-achievement-level service of a request to refrain from using the high-achievement-level service in exchange for giving an incentive, in response to a decrease in the service achievement level in at least one of the plurality of services due to an abnormality in the provision status of the resource.

9. A non-transitory computer-readable storage medium storing a city management support program for causing a computer to execute processing for supporting management of a city in which a plurality of services sharing a finite resource are simultaneously provided, the processing comprising:
acquiring information related to a provision status of the resource;
predicting a service achievement level of each of the plurality of services in future by a predetermined time based on the provision status of the resource; and
notifying a user of a high-achievement-level service of a request to refrain from using the high-achievement-level service in exchange for giving an incentive, in response to a decrease in the service achievement level in at least one of the plurality of services due to an abnormality in the provision status of the resource.
